(19) United States
(12) Patent Application Publication
(10) Pub. No.: US 2007/0033853 A1
(43) Pub. Date: Feb. 15, 2007

(54) Lightweight sound and scent absorption or scent diffusion big game hunting blind and fishing house

(76) Inventor: Glenn Fielding Ridge, Cumming, GA (US)

Correspondence Address: Glenn F. Ridge, 1353 Hester Dr., Cumming, GA, 30040, US

(21) Appl. No.: 11/456,672

(22) Filed: Jul. 11, 2006

Related U.S. Application Data
(60) Provisional application No. 60/698,604, filed on Jul. 11, 2005.

(51) Int. Cl. A01M 31/00

(52) U.S. Cl. 43/1

(57) ABSTRACT

The invention is a lightweight sound and scent absorption or scent diffusion big game hunting and fishing house. The hunting blind, fishing house is a enclosed box stricture in shape having four wall panels with four horizontal sliding windows that open and close, door in one wall panel that opens inward, roof and floor attached to a tower platform and or ground platform each platform has under floor storage. The hunting, fishing house is able to conceal multiple persons within. The blind is supported high and or low above the ground surface. The stairs connected to the tower can be disconnected to form a separate leaning bow hunting tree stair platform. As a fishing house it is supported only with the ground platform with a small trap door in the floor allowing a person or persons to fish through the ice covered lakes or rivers. The hunting blind, fishing house gives the hunter/occupants the highest control of concealment, sound and scent absorption or scent diffusion and weather protection in the outdoors by eliminating the possibility of detection by animal's keen sense of sight, hearing and smell.

### BACKGROUND OF THE INVENTION

1. Field of the Invention

This present invention relates to hunting blinds, leaning tree stair platform and or fishing houses. Specifically, the invention is a enclosed big game hunting blind, fishing house supported and raised low and or high above the ground and or ice surfaces by a ground platform and or tower platform and has an outer surface that blends in with the woodlands, lightweight, sound absorbing interior, interior absorption or diffusion of the hunters/occupants scent, eliminates the possibility of animal's detection by sight, sound and smell, sliding windows, under floor storage container to store hunters occupants gear and or fish, a tower platform with a removable stair platform which can be used as a leaning bow hunting tree stair platform and a fishing house that can be converted into, by using the big game hunting blind.

2. Description of the Art

The art to which the present invention relates includes enclosures, shelters, blinds, and stands for use by hunters, wildlife observers and or ice fishermen. Commonly made of heavy plywood, sheet metals, fiberglass, heavy molded plastics, fabric materials, heavy plywood skinned with aluminum and or sheet metals or heavy panels comprised of polystyrene and or Styrofoam sandwiched between two sheets of metal and or aluminum. Also commonly insulated of no insulation, heavy felt or thick sheet of Styrofoam and or polystyrene. Enclosures, shelters, blinds, stands and ice fishing, shelters require the hunter/occupant to assume an uncomfortable sitting or kneeling position and then open windows outwardly and or stand up to harvest the animal as they approach the blind, this movement can be seen by the animal and will alert them to the hunters present and frighten the animal away. Most enclosures, shelters, blinds, stands and ice fishing shelters do not protect the hunters/occupants from the extreme cold and rainy weather and or the animal's sense of hearing, sight and smell and they are not easily transported and assembled. They are designed primarily to fool the animal's sight and or smell only. Conversely, the present invention is designed for ease of transport, assembly, lightweight, eliminates the possibility of animal's detection by sight, sound and smell while keeping the hunters/occupants out of the harsh weather elements.

There are several patents, which disclose enclosures, shelters, blinds, stands and ice fishing shelters of various constructions.

Hall, U.S. Pat. No. 5,241,772 discloses a hollow cylindrical hunting blind, supported on the ground or on a tower. Formed of elongate molded panels and a domed roof that has a rain channel to capture and direct rain water downwardly between the windows, an a outer surface corrugations simulating the bark of a tree a small peep window above the lower windows an a flexible cable having a control knob opens and closes windows. Mounted in the enclosure a swivel chairs, and a ladder-stand connected to the tower can be disconnected to serve as a leaning tree stand that a hunter can climb up to hunt from.

Fargason, U.S. Pat. No. RE38,321 discloses a scent-free blind room-like shelter having a door, a plurality of windows, a small vent near ground level, and a flexible 4-inch diameter tube extending from the top of the shelter to a height of 30 feet from the ground. This allows the shelter to vent out the occupants odors up through the tube high enough so that nearby animals will not smell the occupants.

Adams, U.S. Pat. No. 6,009,673 discloses a hunting blind, an ice fishing shelter, wildlife observatory comprises a plurality of rigid, insulated panels installed in a plurality of track members mounted on the roof and floor and configured to receive the top and bottom edges of the wall panels having windows and a door. The walls, door, roof panels comprises a metallic outer skin encapsulating a core of expanded polystyrene. The hunting blind, an ice fishing shelter has a plurality of lift handles mounted to the panels to facilitate transport of the enclosure over ground or skies to facilitate transport over ice covered lakes. The enclosure sits directly on the ground and on the ice covered lakes.

Horsmann, U.S. Pat. No. 4,794,717 discloses a hunting blind shaped like a bale of hay comprising tenting material covering a tubular frame.

Sury, U.S. Pat. No. 4,798,019 discloses a box-shape blind having a tubular frame and fabric covering. The top is see through, and the sides have loops for holding surrounding vegetation to disguise the blind.

Reneau, U.S. Pat. No. 4,606,142 discloses an elevated blind without any cross-brackets between the legs, intended to make assembly easier.

None of the above inventions and patents, taken either singularly or combination, is seen to describe the instant invention as claimed. Thus a big game hunting blind/fishing house solving the aforementioned problems is desired.

### SUMMARY OF THE INVENTION

The present invention is a lightweight thermal insulated, sound and scent absorption or scent diffusion, permanent and or portable ground platform and or tower platform big game hunting blind and fishing house with or without the tree break-up pattern on the exterior resembles a tree line and the surrounding woodlands.

The ground platform and or tower platform allows hunting blind, fishing house to be elevated low and or high above the ground and or ice covered lakes and or rivers.

The hunting blind, fishing house comprises four wall panels with horizontal sliding windows, a door panel mounted with hinges in one of the wall panels allowing the door to open inward with two locking mechanism, exterior and interior, a sun rain gutter shield above all exterior openings jetting outward, a roof panel and floor with under floor storage for gear and or fish.

It is an object of the invention to provide breakup and concealment of the hunters/occupants body, allowing the hunters/occupants freedom of movement within the hunting blind, fishing house without the animal's awareness by the animal's keen sense of sight, hearing, and smell.

It is an object of the invention to provide hunters/occupants the ability to talk within the hunting blind, fishing house without the animal's awareness by its keen sense of hearing.

It is an object of the invention to provide the combination of the corrugated plastic sheets and or aluminum laminated corrugated plastic sheets for the exterior panels, fabricated to a lightweight material frame, with the use of the scent absorbing fiber filament inserts or the scent diffusion fiber filament inserts inserted into the interior of the framed panels. Providing the invention primary multiplicity of purpose thereby forming a thermal insulated air barrier that insulates against the extreme cold and rainy weather, absorbs all interior sounds and eliminates the hunters/occupants scent by absorption or diffusion, eliminating the possibility of detection by animal's keen sense of sight, hearing and smell.

It also provides the invention the lightest in weight for its class as a permanent hunting blind, fishing house attached to a ground platform and or tower platform.

The primary purpose of sound absorption and scent diffusion is performed with the windows in an open and or closed position, allowing the hunters/occupants a worry free hunt.

It is an object of the invention to provide the hunter/occupants the ability to be completely out of the weathers environmental elements, being completely enclosed inside the hunting blind, fishing house.

It is an object of the invention to provide sliding windows allowing the hunters/occupants to manually open and place a rifle outside of the blind to harvest big game and to manually close after the harvest.

It is an object of the invention to provide the hunter/occupants ground platform and tower platform in the floor a door that's opens tip to a under floor storage container allowing hunters/occupants to store gear and fish.

It is a further object of the invention to provide a leaning bow hunting tree stair platform when disconnected from the tower platform allowing the hunter to walk up atop the platform to harvest big game elevated above the ground with a bow.

Still another object of the invention to convert the hunting blind into a portable ground platform fishing house allowing the hunters/occupants to ice fish above and through frozen lakes and rivers.

It is an object of the invention to provide improved elements and arrangements thereof for the purposes described which is fully effective and dependable in accomplishing its intended purposes.

These and other objects of said present invention will become readily apparent upon further review of the following specification and drawings.

### BRIEF DESCRIPTION OF THE DRAWINGS

FIG. 1 is an perspective view of preferred embodiment of the lightweight sound and scent absorption or scent diffusion big game hunting blind, fishing house of this present invention shown erect on top of a tower platform, which has a removable stair platform attached.

FIG. 1A is an exploded perspective view of one embodiment of the lightweight sound and scent absorption or scent diffusion big game hunting blind, fishing house showing the assembly components of the wall panels and details A, and B of the corrugation channels in the exterior plastic sheets of this present invention.

FIG. 1B is an perspective view of one embodiment of the lightweight sound and scent absorption or scent diffusion big game hunting blind, fishing house showing the inside components of the wall panels of this present invention.

FIG. 1C is an perspective view of one embodiment of the lightweight sound and scent absorption or scent diffusion big game hunting blind, fishing house showing the interior components of the wall and door panel of this present invention.

FIG. 1D is an exploded perspective view of one embodiment of the lightweight sound and scent absorption or scent diffusion big came hunting blind, fishing house showing the assembly components of the roof panel of this present invention.

FIG. 2 is an exploded perspective view of the transformation embodiment of the lightweight sound and scent absorption or scent diffusion big game hunting blind to the fishing house showing the floor with the storage door and trapdoor with hole to fish through and the ground platform with storage container of this present invention.

FIG. 3 is a perspective view of one embodiment of the lightweight sound and scent absorption or scent diffusion big game hunting blind, fishing house stair platform of this present invention is disconnected from the tower platform showing the use of the tree ratchet tie down to secure the stair platform to a tree, transforming it into a bow hunting tree stair platform.

FIG. 3A is an exploded perspective view of one embodiment of the lightweight sound and scent absorption or scent diffusion big game hunting blind, fishing house and the stair platform that is disconnected from the tower platform showing the assembly components with the tree anchor bracket, fasteners and the tree center brace with center brace stair fastener of this present invention.

FIG. 3B is a perspective view the tree anchor bracket for the stair platform of this present invention.

FIG. 3C and FIG. 3B is a perspective view of one embodiment of the lightweight sound and scent absorption or scent diffusion big game hunting blind, fishing house stair platform showing the step tread and the cross section of this present invention.

FIG. 4 is an exploded perspective view of the preferred embodiment of the lightweight sound and scent absorption or scent diffusion big game hunting blind, fishing house and the tower platform showing the assembly components with the stair platform disconnected of this present invention.

FIG. 5 is a perspective view of one embodiment of the lightweight sound and scent absorption or scent diffusion big game hunting blind, fishing house showing the horizontal sliding windows assembly components of this present invention.

FIG. 6 and FIG. 6A is a exploded and cross section perspective view of one embodiment of the lightweight sound and scent absorption or scent diffusion big game hunting blind, fishing house showing the sun, rain, gutter shield assembly components of this present invention.

### DETAILED DESCRIPTION OF THE PREFERRED EMBODIMENTS

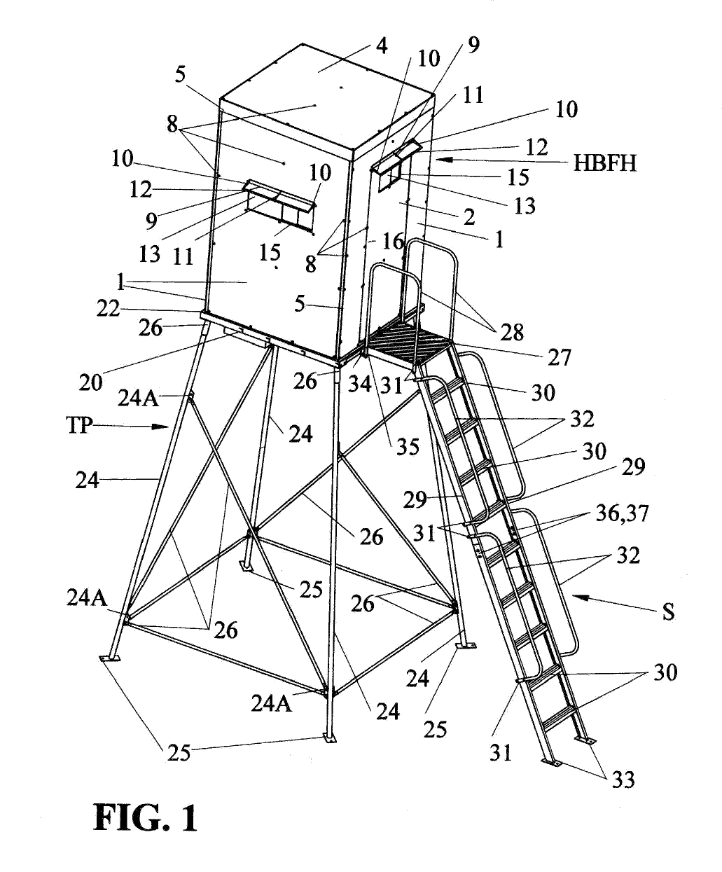

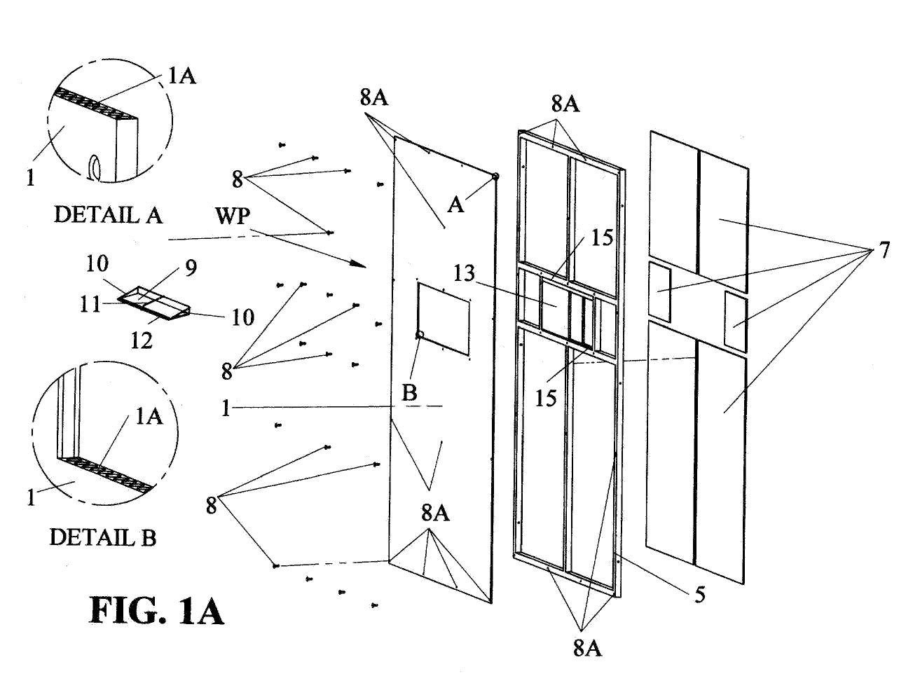

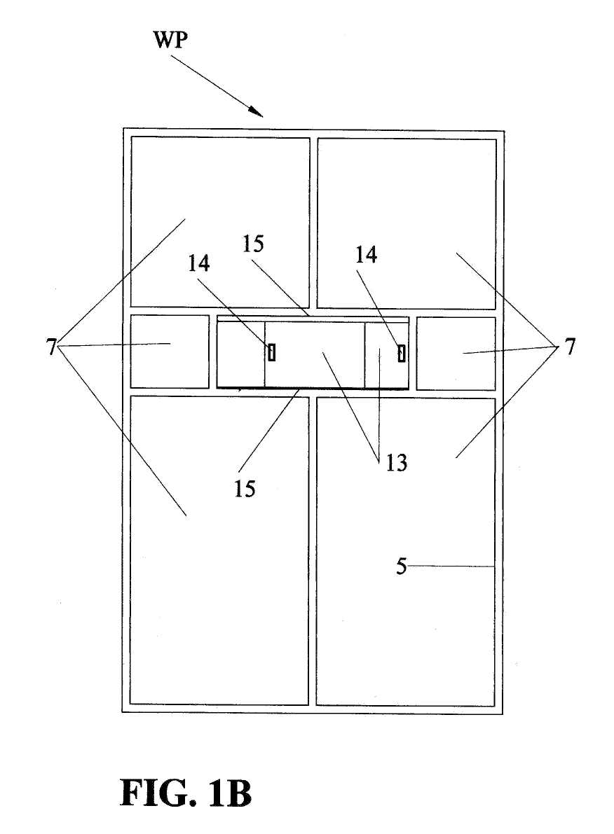

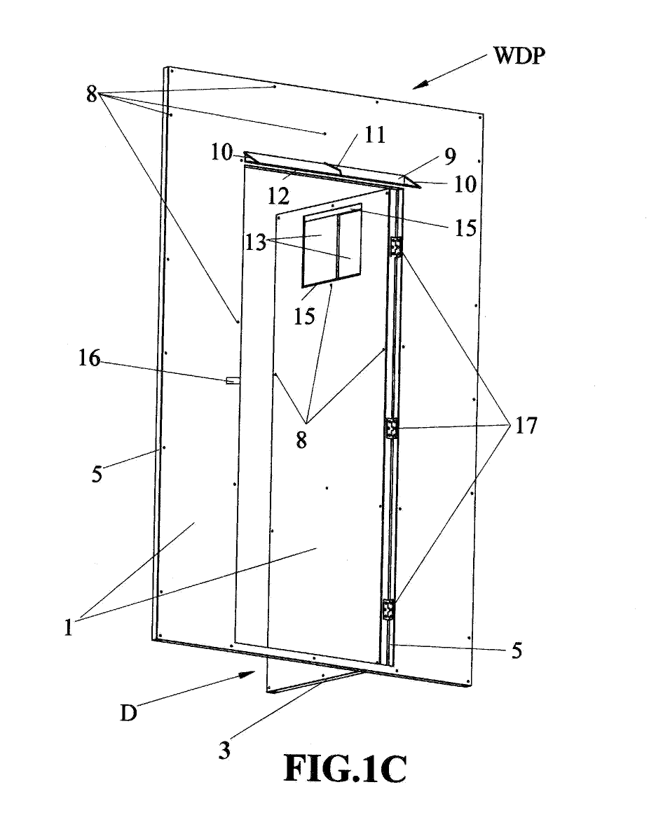

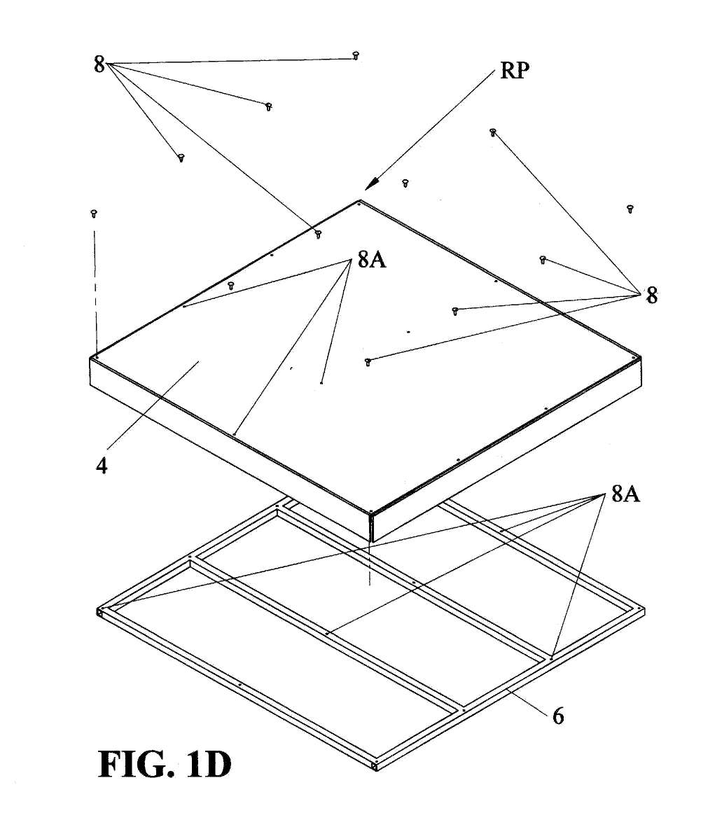

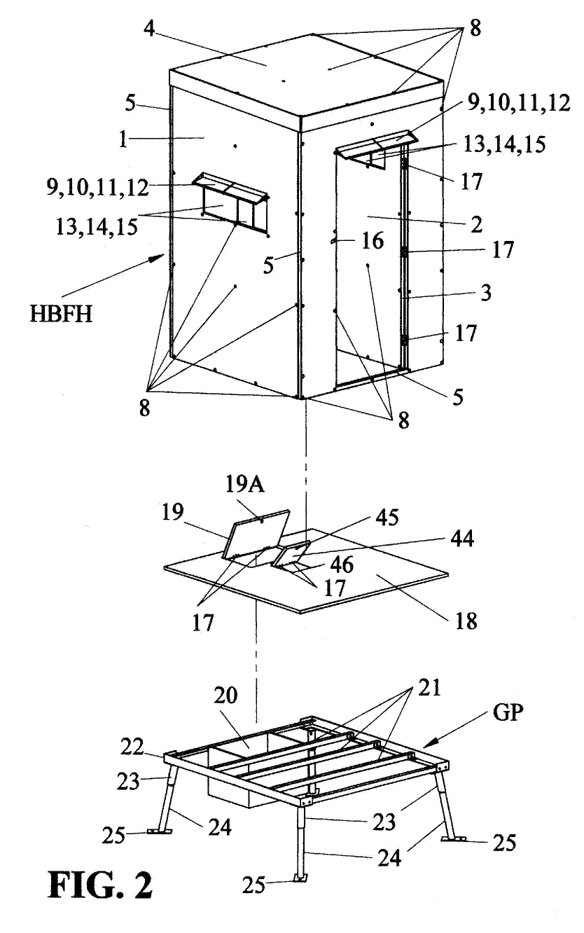

Referring to FIGS. 1 through FIG. 2, the present invention, a preferred embodiment of a lightweight sound and scent absorption or scent diffusion big game hunting blind, fishing house HBFH that is erect on top of a tower platform TP or mounted on top of a ground platform GP. The tower platform TP has removable stair assembly S containing a platform 27; step treads 30 safety rails 28, handrails 32 and stair anchor feet 33. When attached to the tower platform TP the stair assembly S provides the ability for entry and exit through a door D that swings inward to open with a locking mechanism 16 giving the hunter/occupants the ability to lock the big game hunting blind, fishing house.

As shown in FIG. 1A, each of the four wall panel WP and one wall panel WP with door D are assembled with assembly components which consists of a wall frame of lightweight metallic material 5 with an exterior wall panel of corrugated plastic sheet 1 (detail A and detail B shows the corrugation channels in the exterior plastic sheets of this present invention), which are held together with mounting fasteners 8 through fastener holes 8A with slide track 15, horizontal sliding window 13 window pull (not seen) and fiber filament inserts 7 inserted into the interior of the wall frame of lightweight metallic material 5.

On the exterior wall panel of corrugated plastic sheet 1, mounted above jetting outward away from the horizontal sliding window 13 a sun, rain, gutter shield 9 along with side braces 10 and a center brace 11 allowing the sun, rain, gutter shield 9 to maintain a slight downward slop to direct rain water into the gutter 12 and expelling it off the outer sides of the horizontal sliding window 13.

As shown in FIG. 1B, the interior of three of the wall panel WP consists of fiber filament inserts 7, slide track 15, window pulls 14 secured to horizontal sliding window 13 inserted into the wall frame of lightweight metallic material 5 in the interior.

As shown in FIG. 1C the interior of the forth wall panel WP containing the door D consists of fiber filament inserts 7, inserted into the wall frame of lightweight metallic material 5 in the interior. Above the door opening on the exterior wall panel of corrugated plastic sheet 1 (not seen) is mounted the sun, rain, gutter shield 9 along with side braces 10 and a center brace 11 allowing the sun, rain, gutter shield 9 to maintain a slight downward slop to direct rain water into the gutter 12 expelling it off the outer sides.

The door D consists of fiber filament inserts 7, the slide track 15, window pulls 14 secured to horizontal sliding window 13 and inserted into the interior of the doorframe of lightweight metallic material 3. The door D mounts to one of the wall panel WP with the use of hinges 17 allowing the door D to swing inward into the enclosed box structure.

As shown in FIG. 1D the roof panel RP assembled using the assembly components, which consist of a roof frame of lightweight metallic material 6 with an exterior roof panel of corrugated plastic sheet 4, held together by mounting fasteners 8 through the fastener holes 8A.

When all panels are complete tour wall panels WP, one wall panel WP with the door D and the roof panel RP are then assembled together using fasteners, to form an enclosed box structure that is erect on top of a tower platform TP or mounted on top of a ground platform GP.

As shown in FIG. 2 the complete lightweight sound and scent absorption or scent diffusion big game hunting blind, fishing house HBFH is converted into the fishing house mounted on top of the ground platform GP with fasteners.

The floor 18 for the fishing house has a storage door 19 mounted with hinges 17 with a finger pull in the top edge of the storage door 19 allowing access into the storage container 20. The trapdoor 44 and floor hole 46 is located just in front of the storage door 19 and is mounted with hinges 17 to the floor 18.

The floor 18 is mounted to the ground platform GP frame with fasteners. The frame of the ground platform GP is an assembly of horizontal frame platform 22 with floor-joist supports 21 connected between the horizontal frames by fasteners. Fastened under and in-between the horizontal frame platform 22 and floor-joist support 21 is the storage container 20. Under the four outer corners of the horizontal frame platform 22 are four tubular leg sleeves 23 that are fay together one at each outer corner. These four tubular leg sleeves 23 allows the tubular legs 24 to slide-up inside and fasten into place. At the opposite end of the tubular legs 24 are leg anchor feet 25, allowing the ground platform GP tubular legs 24 to rest flat and anchor to the ground or ice surface.

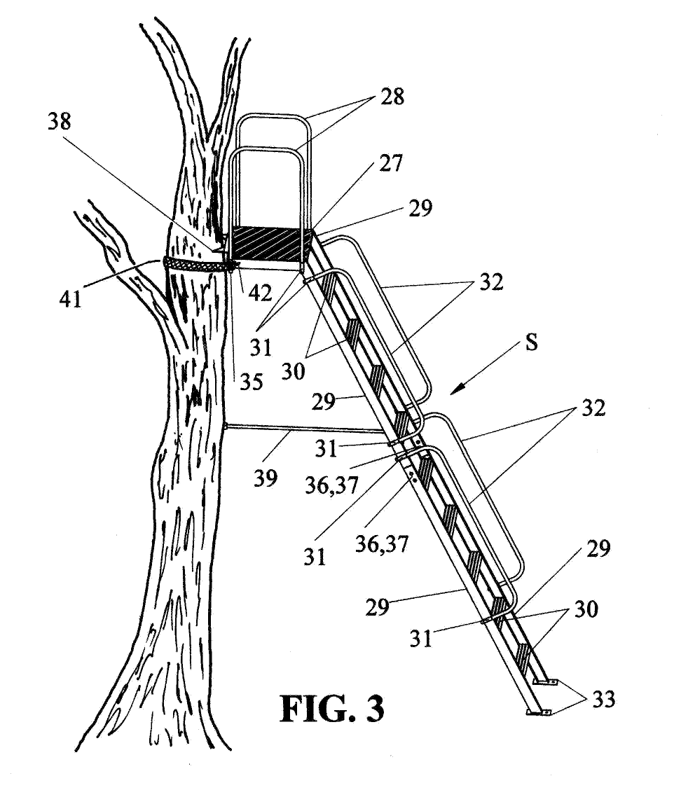

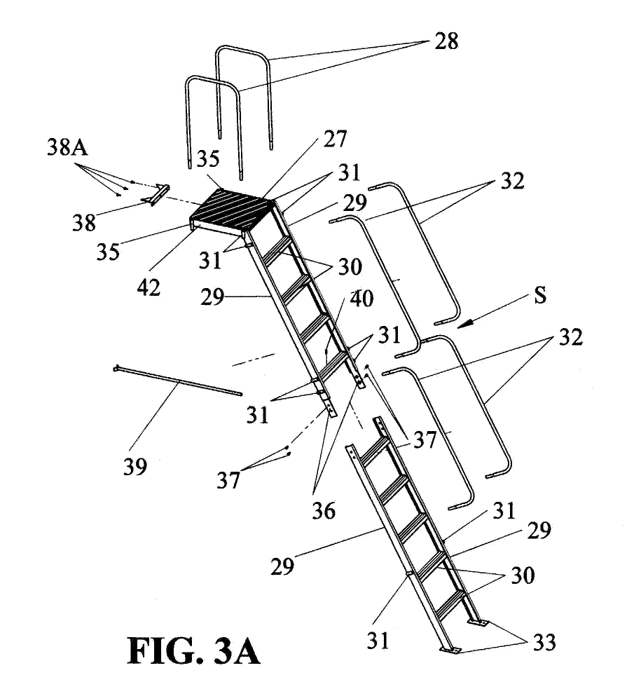

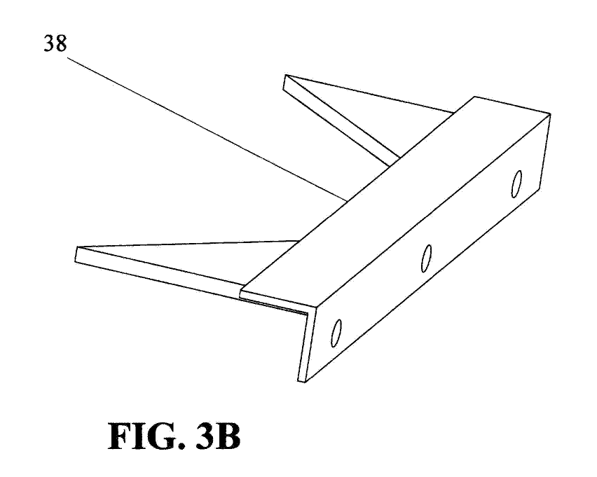

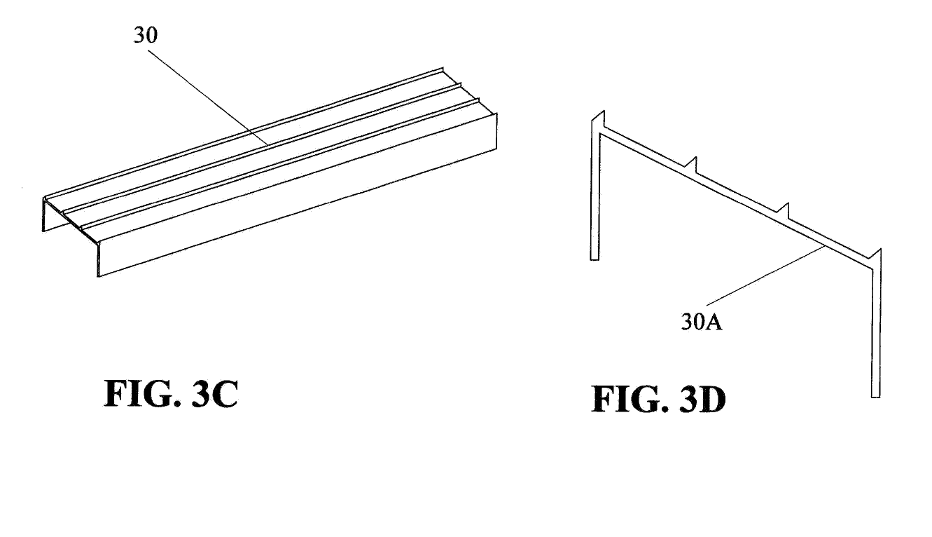

In the preferred embodiment shown in FIGS. 3 through 3D is the stair assembly S that has been disconnected from the tower platform TP, allowing the stair assembly S to be used as a bow hunting tree stair platform by attaching the tree anchor bracket 38 to the front connecting edge of the platform 27 along with connecting the stair center brace 39 to the stair center brace step fastener 40. After the tree anchor bracket 38 and the stair center brace 39 has been connected to the stair assembly S, the platform 27 is secured to the tree by connecting the tree ratchet tie down 41 around the tree to the tie down anchor holes 42 located at both sides of the platform 27 and ratchet down tight until the tree anchor bracket 38 and the stair center brace 39 bites into the tree.

As shown in FIG. 3A the assembly process for the stair assembly S before its connected to the tower platform TP or a tree.

The top section of the stair assembly S consist of the platform 27, the diagonal step tread assembly 29, center brace step fastener 40 and the split stair connection 36 which is connected to the lower section of the diagonal step tread assembly 29 by sliding the two ends together and securing the two section as one with the stair fasteners 37. At the opposite end of the lower section of the diagonal step tread assembly 29 and located at the bottom of the stair assembly S is the stair anchor feet 33, this is used to secure the stair assembly S to the ground surface. After the two sections of diagonal step tread assembly 29 having a series of handrail brackets 31 on the outer sides, are assemble. Sliding the handrails 3 into the handrail brackets 31 and secured in place by fasteners connects the handrails 32. At top of the Platform 27 the two safety rails 28 are connected by sliding one end of the safety rails 28 into the stair/tower fasteners safety rail brackets 35 located at the front edge an the other end of the safety rails 28 into the handrail brackets 31 located at the outer sides at back of the platform 27 just above the top step tread 30 an secured in place by fasteners.

The tree anchor bracket 38, tree anchor fasteners 38A and the stair center brace 39 is only connected to the stair assembly S when disconnected from the tower platform TP an in use as a bow hunting tree stair platform.

FIG. 3B is a larger view of the tree anchor bracket 38, FIG. 3C is a larger view of the step tread 30 showing the detail of the top surface and FIG. 3D showing the cross-section of the step tread 30.

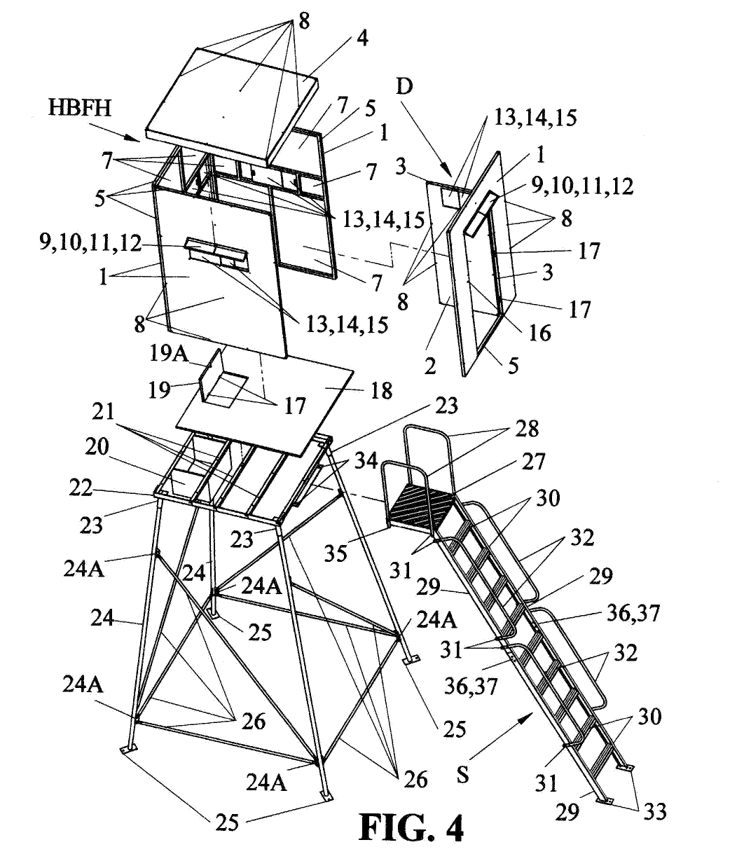

In the preferred embodiment shown in FIG. 4 and FIG. 2 the lightweight sound and scent absorption or scent diffusion big game hunting blind, fishing house HBFH being assembled erect on top of a tower platform TP or may be assembled as shown in FIG. 2 mounted on top of a ground platform GP. Each having four-wall panel WP a door D and a roof panel RP. The four wall panel WP consists of exterior wall panel of corrugated plastic sheet 1 a wall frame of lightweight metallic material 5 held together with mounting fasteners 8 through a series of fastener holes 8A in the exterior wall panel of corrugated plastic sheet 1 and the wall frame of lightweight metallic material 5 with slide tracks 15, window pulls 14 secured to window 13 and fiber filament inserts 7 inserted into the interior of the wall frame of lightweight metallic material 5.

One wall panel WP having a locking mechanism 16 and door D mounted to the wall panel WP with hinges 17 allowing the door D to swings inward to open, consists of exterior door panel of corrugated plastic sheet 2, a door-frame of lightweight metallic material 3 with slide tracks 15, window pulls 14 secured to window 13 and fiber filament inserts inserted into the wall frame of lightweight metallic material 5 in the interior.

All wall panels all WP mounted on the exterior wall panel of corrugated plastic sheet 1 above jetting outward away from the window 13 and door D, a sun, rain, gutter shield 9 along with side braces 10 and a center brace 11 allowing the sun, rain, gutter shield 9 to maintain a slight downward slop to direct rain water into the gutter 12 and expelling it off the outer sides of the window 13.

The roof panel RP consists of exterior roof panel of corrugated plastic sheet 4 a roof frame of lightweight metallic material 6 held together with mounting fasteners 8 through a series of fastener holes 8A in the exterior roof panel of corrugated plastic sheet 4 and the roof frame of lightweight metallic material 6.

When all four wall panels WP, one wall panel WP with door D and a roof panel RP are complete, they are assembled using fasteners, to form an enclosed box structure that is secured to the floor 18 with a door D that swings inward to open allowing the hunter/occupants to enter or exit.

The floor 18 for the big game hunting blind, fishing house HBFH has a storage door 19 mounted with hinges 17 and a linger pull in the top edge of the storage door 19 allowing access into the storage container 20.

The floor 18 is mounted to the tower platform TP or mounted on top of a ground platform GP with fasteners. The frame of the tower platform TP is an assembly of horizontal frame platform 22 with floor-joist supports 21 connected between the horizontal frames by fasteners. Fastened under and in-between the horizontal frame platform 22 and floor-joist support 21 is the storage container 20. Under the four outer corners of the horizontal frame platform 22 are four tubular leg sleeves 23 that are fay together, one at each outer corner. These four tubular leg sleeves 23 allows the tubular legs 24 to slide-up inside and fasten into place. At the opposite end of the tubular legs 24 are anchor feet, allowing the tower platform tubular legs 24 to rest flat and anchor to the ground or ice surface. Attached to the tubular legs 24 are a series of tubular diagonal and horizontal traves 26, stabilizing the tower platform TP. Attached to the tower platform TP at one end of the horizontal frame platform 22 is the stair-connecting bracket 34, at this juncture the stair assembly S is mounted and secured with the star/tower fastener safety rail brackets 35 to the tower platform TP.

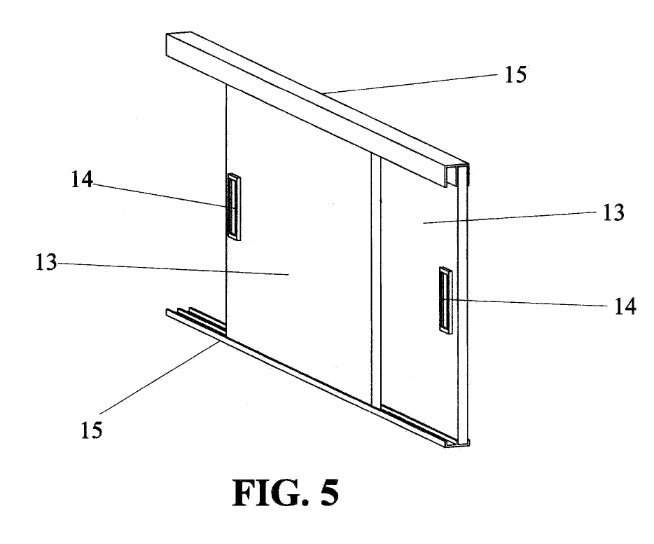

In the preferred embodiment shown in FIG. 5 the perspective of the horizontal sliding windows 13 and the assembly of. Having slide tacks 15 with a split center as shown, with horizontal sliding windows 13 in between and on either side of the split center. This allows the horizontal sliding windows 13 to pass each other when open with the use of the window pulls 14. The window pulls 14 are secured on the opposite sides of the horizontal sliding windows 13 providing the hunters/occupants the ability to manually open using the window pulls 14 and place rifle outside of the big game hunting blind, fishing house HBFH to harvest big game and to manually close using the window pulls 14 after the harvest of this present invention.

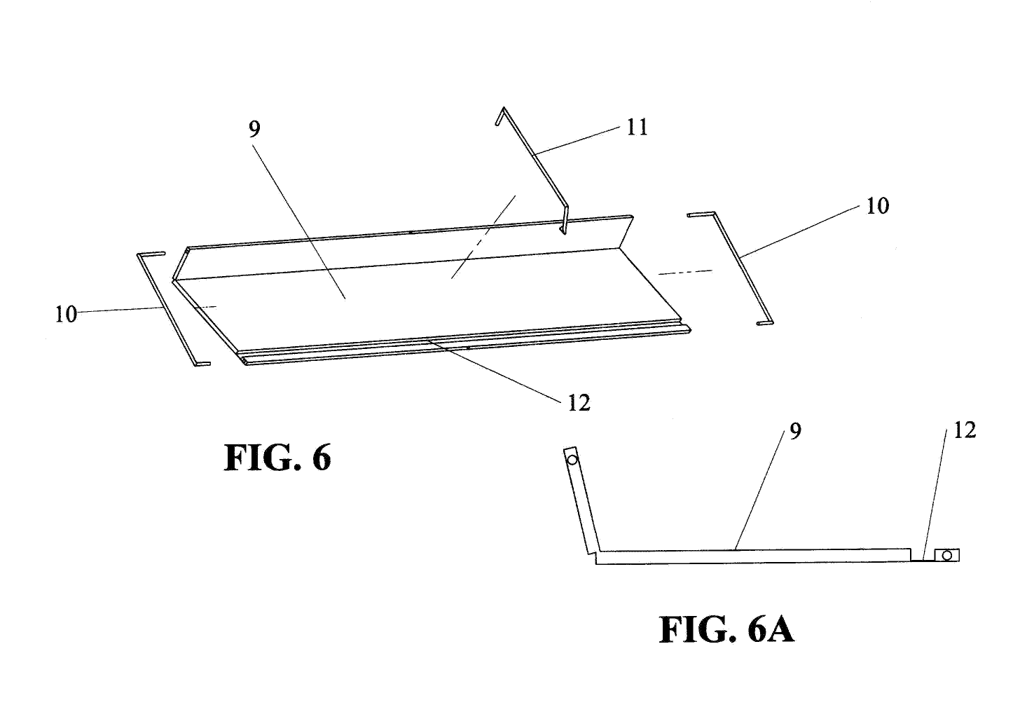

In the preferred embodiment shown in FIG. 6 and FIG. 6A an exploded and cross section perspective showing the sun, rain, gutter shield 9 assembly components. The sun, rain, gutter shield 9 along with side braces 10 and a center brace 11. This allows the sun, rain, gutter shield 9 to maintain a slight downward slop to direct rainwater into the gutter 12 expelling it off the outer sides. FIG. 6A shows the cross section of the sun, rain, gutter shield 9 and the gutter 12, without the side braces 10 and a center brace 11 of this present invention.

The invention, a lightweight sound and scent absorption or scent diffusion big game hunting blind, fishing house with or without the tree break tip pattern printed on the exterior of said walls resembles a tree line and the surrounding woodlands, has been tested with the inventor inside and has experienced, big game and other animal's coming to feeding around and staying within a yard of the lightweight sound scent absorption or scent diffusion big game hunting blind, fishing house while having all windows open, for an hour an a half before the big game and other animal's slowly moving off.

It should be understood that the present invention is not restricted to the embodiments described above, but encompasses any and all embodiments within the scope of the following claims.

I claim:

1. A big game hunting blind, fishing house comprising:
an enclosed box structure for concealing, hunters/occupants, sounds, and scent from animal's sight, hearing and smell;
said structure having four wall panels, door panel, roof panel an a tree break-up pattern on the exterior panels with an interior, and having a floor with under floor storage, tower platform and or ground platform;
said panels and floor are joined together along adjacent side, top and bottom edges, and attached to the top of said tower platform and or ground platform;
each said panels are constructed of conjugated plastic sheet for the exterior of said panels, a frame of lightweight material forming a skeleton for said panels and one of two types of fiber filament inserts are used for the interior of said panels, scent absorbing fiber filament inserts or scent diffusion fiber filament inserts;
the uses of mounting clips, connects each said exterior panels of corrugated plastic sheets to said frame;
at least one window opening exists in said wall panels, and on the exterior side of said wall panels attached above jetting outward away from said window openings a sun rain gutter shield and mounted in the interior of said window opening at least one quite horizontal sliding window on tracks allowing the hunter to open and close windows;
one wall panel with a door mounted with hinges in said wall panel, said door opens inward with locking mechanism, exterior and interior, one quite horizontal sliding window on tracts allowing said window to open or close and a sun rain gutter shield attached above, jetting outward away from said opening.

2. A big game hunting blind, fishing house according to claim 1 including, a tree break up pattern printed on the exterior of said wall panels resembles a tree line and the surrounding woodlands.

3. A big game hunting blind, fishing house according to claim 1, wherein said exterior panels constructed of corrugated plastic sheets and or aluminum laminated corrugated plastic sheets, the corrugation of said plastic sheet allows air to be trapped within its corrugation thereby forming a insulated thermal air barrier allowing said panels to absorb sounds from within said enclosed structure, whereby eliminating the possibility of detection by animal's.

4. A big game hunting blind, fishing house according to claim 1, wherein said interior of said panels are one of said two types of fiber filament inserts used, the said scent absorbing fiber filament inserts are used to absorb hunters/occupants scent without the use of natural outdoor cover scents or the said diffusion fiber filament inserts are used with a application of a natural outdoor cover scent to said scent diffusion fiber filament inserts along with air movement through said scent diffusion fiber filament inserts within said enclosed structure, thereby creating a diffusion of hunters/occupants scent and said natural outdoor cover scent, whereby eliminating the possibility of detection by animal's.

5. A big game hunting blind, fishing house according to claim 4, wherein said scent is eliminated by absorption or diffusion of said hunters/occupants odors and scent.

6. A big game hunting blind, fishing house according to claim 1, wherein combining said corrugated plastic sheets and ether of said two types of fiber filament inserts, thereby creating additional thermal insulated air barrier and sound absorption to said panels

7. A big game hunting blind, fishing house according to claim 6, wherein combining said corrugated plastic sheets and ether of said two types of fiber filament inserts, thereby creating additional thermal insulation to said interior thereby providing said hunters/occupants greater retention of heat in cold weather, within said interior.

8. A big game hinting blind, fishing house according to claim 1, wherein said sun rain gutter shield that is attached above, jetting outward away from said windows and door blocking the direct sun and sheds rain water into a built in gutters on the outer edge expelling said rain water off the outer sides of said windows and door.

9. A big game hunting blind, fishing house according to claim 1, wherein said window is formed of a clear transparent material allowing said hunters/occupants to see out of said structure and including at lest one window pull allowing said windows to open and closed.

10. A big game hunting blind, fishing house according to claim 1, wherein said enclosed structure is attached to said floor of said tower platform and or ground platform.

11. A big game hunting blind, fishing house according to claim 10, including a tower platform and or ground platform constructed out of a assembly of tubular materials fay together having a horizontal framed platform with floor, four outer corners an array of joist supports at its top end to engage and support said floor thereon a plurality of tubular leg sleeves each fay at one end and under each said outer corners and the opposite ends of each extending angled downwardly and away there from, said floor being fay to said platform support and a plurality elongated tubular legs each having one end sliding into and received by said tubular leg sleeves and fay together and their opposite ends with anchor feet each extending angled downwardly and away and having tubular diagonal and horizontal traves connecting to each said tubular leg there from to support said enclosed box structure high and or low above the ground and or ice surface.

12. A big game hunting blind, fishing house according to claim 11, wherein said tower platform and or ground platform in said floor at least one door that opens up at least one under floor storage container allowing said hunters occupants to store gear out of their way, said storage container attaches to the underside and between said floor joist supports.

13. A big game hunting blind, fishing house according to claim 1, including a stair assembly with an platform step treads safety rails and hand rails that connect to said tower platform, allowing said hinters/occupants to walk tip to enter and exit said enclosed box structure atop of said tower platform in safety, said stair can be disconnected to form a separate bow hunting tree stair platform also allowing said hinters/occupants to walk up atop the platform and by using a ratchet tie down to fay against tree for stability.

14. A big game hunting blind, fishing house according to claim 1, wherein said enclosed structure can be used as a portable fishing house for ice fishing on top of frozen lakes and rivers.

15. A big game hunting blind, fishing house according to claim 14, wherein said enclosed structure can be used as a portable fishing house, said fishing house is supported off said ice by said ground platform, existing in said floor and next to said storage door is at least one trapdoor covering a hole, allowing hunters occupants to fish through the said floor on ice covered lake and or river.

16. A big game hunting blind, fishing house according to claim 1, wherein said enclosed structure is a ridged lightweight structure that one hunter/occupant can transport and assemble with eases.
